(19) United States
(12) Patent Application Publication
(10) Pub. No.: US 2005/0036305 A1
(43) Pub. Date: Feb. 17, 2005

(54) Underwater lighting devices

(76) Inventor: Douglas Graeme Kersey, Robina (AU)

Correspondence Address: SHOEMAKER AND MATTARE, LTD, 10 POST OFFICE ROAD - SUITE 110, SILVER SPRING, MD, 20910, US

(21) Appl. No.: 10/915,468

(22) Filed: Aug. 11, 2004

(30) Foreign Application Priority Data
Aug. 12, 2003 (AU) 2003904238

(51) Int. Cl. F21S 6/00

(52) U.S. Cl. 362/149

(57) ABSTRACT

An underwater lighting device for use with a liquid container such as a swimming pool having a return line for returning water to the pool, the lighting device including a main support body for supporting light emitting diodes, the main support body having a fluid outlet and hollow spigot extending from the main support body for engagement with the return line such that fluid can flow from the return line through the outlet.

### REFERENCE TO EARLIER APPLICATION

This Application claims the benefit of Australian Provisional Patent Application No. 2003904238, filed Aug. 12, 2003, by Douglas Graeme Kelsey, entitled Underwater Lighting Devices.

### BACKGROUND OF THE INVENTION

The present invention relates to lighting devices, and in a particular but not exclusive aspect to underwater lighting devices for use in swimming or spa pools to illuminate the volume of water in a swimming or spa pool. The lighting devices of the invention however may also be used in other applications where a light source is required for use in or in close proximity to water such as in fountains or water features.

Most commonly, existing light assemblies used in underwater installations such as swimming pools use high wattage globes (up to 150 Watt) which are contained in a sealed housing. The globes which are used require replacement at regular intervals. Replacement of the globes is often a difficult task as it is necessary to remove the assembly from the underwater location, open the sealed housing to enable the globe to be removed and replaced, and then reseal the housing. Usually each light assembly is supplied with current from a separate transformer. Furthermore, the known light assemblies are usually installed in the wall of a pool or other water container with wiring for supply of current to the light assemblies provided through dedicated conduits which penetrate the wall of the pool or other water container. Provision for these forms of light assemblies is therefore required to be made at the time of construction of a pool or other water container.

It is common also for light assemblies to be used in systems for illumination flowing water to provide a pleasing and attractive appearance to the observer. These systems may be used in connection with swimming or spa pools such as in bubblers or sprayers or in fountains or other water features. In these systems, the light sources are usually located separately and remote from the water outlets which necessitates separate installation of the plumbing system for supplying water to the water outlets and the electrical system for supplying the light sources. Consequently, these systems tend to be relatively expensive both in capital costs and installation costs.

### SUMMARY OF THE INVENTION

The present invention aims to provide an improved lighting device which overcomes or at least alleviates one or more of the above disadvantages. In one particular aspect, the present invention aim to provide an underwater lighting device for use in swimming pools, spa pools or in any other underwater application. In another aspect, the present invention aims to provide a lighting device for use in water features such as fountains or sprayers or any other application where water or a water flow is to be illuminated. Other objects and advantages of the invention will become apparent from the following description.

The present invention thus provides in one aspect, an underwater lighting device for use with a liquid container of the type having at least one return line for returning water to said liquid container, said lighting device including a main support body for supporting one or more light sources, and locating means for cooperation with said return line to locate said lighting device in said liquid container.

The main support body may have one or more water outlets through which water flowing through the return line can return to the water container.

In one configuration, the lighting device may be supplied with current remotely from a suitable power supply and the current supply to the light source is provided by suitable wires or cables extending along the return line between the power supply and the lighting device assembly. In another configuration, the lighting device may be self contained and include its own power supply suitably in the form of a battery or batteries.

The liquid container may be a swimming pool, pond such as a fish pond, a water fountain, fish tank or any other form of liquid container, the contents of which are required to be illuminated.

The locating means in one form may comprise engagement means which are suitably frictionally engageable with the return line whereby the lighting device can be installed into or removed from the return line. In an alternative arrangement, the locating means may be attached to the return line by any suitable attaching means. The attaching means may comprise adhesive means such as a solvent adhesive or alternatively may comprise a fastener or fasteners or screw threads.

Most preferably, the main support body has a liquid outlet or outlets for flow of water from the return line to the water container. The main support body may comprise a known pool return fitting such as an eyeball fitting or “letterbox” fitting and the locating means comprises a spigot formed integrally with or fixed to the main body. The spigot is suitably of hollow tubular form and defines a flow passage for communicating water from the return line to the liquid outlet or outlets.

The main support body suitably has a front face and the light source is on the front face. Suitably the light source comprises at least one solid state light emitting device such as a light emitting diode (LED). The light source most preferably comprise a plurality of light emitting diodes (LEDs) arranged in any suitable array. The array may comprise an array in which the LEDs are arranged in one or more rows, along a circular path, in combinations of rows or in circles or in any other configuration.

The one or more light sources in an alternative embodiment may comprise one or more incandescent light sources or gas tubes.

In a further aspect, the present invention provides a multidirectional underwater lighting device for use in a liquid container, said lighting device comprising a light source supporting body for supporting a light source and a mounting portion for mounting said supporting body to said liquid container, said support body being movable relative to said mounting portion in a plurality of directions relative to said mounting portion.

Preferably, the mounting portion is releasably engageable with a pipe section or housing in a wall of the water container. Most preferably, the mounting portion is frictionally engageable with the pipe section or housing. The mounting portion may comprise a spigot for frictional engagement with the pipe section or housing. Alternatively, the mounting portion may be attached by any other means to the pipe section or housing such as by adhesives or fasteners.

Most preferably, the support body and mounting portion are portions of a known pool return fitting such as an eyeball fitting with the support body comprising the eyeball of the fitting and the mounting portion including a spigot for frictional engagement with the pipe section of housing. The light source suitably comprises a one or more light emitting diodes mounted on the eyeball.

The devices of the present invention allows for easy installation of lights in an existing body of water without the need to empty the vessel or container, drill holes or trench for conduits. Further, the apparatus of the present invention provides for the safe and easy decorative illumination of fish ponds, water fountains, fish tanks and the like.

Where solid state light sources such as LEDs are used, the need to provide a transformer for every light installed can be eliminated thereby resulting in a cost saving. Sold state light sources emit a soft glow to the water, rather than a strong point of light, and as the light assemblies can be left on for long periods without detrimental effect to themselves, they can act as a safety feature by illuminating the body of water, even when all external lighting has been extinguished

The lighting devices in the preferred form utilise low voltage and minimum current draw to operate and depending on size of the transformer or battery, multiple light assemblies can be lit from the one power source.

The lighting devices of the present invention may be used as a stand-alone standard illumination device for new pools and the like. Installation is easier than existing lights, only requiring a standard sized pipe to be installed in the wall and a conduit returning to the power source.

In some embodiments, the underwater lighting devices may provide localised lighting from within a body of water and at the same time allow water to return to the body of water. When applied to existing plumbing such as pool return lines, the need for additional holes to be drilled through the wall of the vessel or container is eliminated, thereby eliminating an additional source of possible leaking.

The lighting devices of the present invention although particularly suitable for use underwater, can be used anywhere, in or out of the water, to provide a waterproof light source for any application. A typical application is in fountains or other water features, garden lights which incorporate water sprays or flowing water or waterfalls.

The present invention thus provides in a further aspect a lighting device including a housing adapted to be connected to a source of fluid, said housing having a fluid flow outlet for said fluid, and said housing supporting one or more light sources for illuminating fluid flow through said outlet.

The fluid flow outlet may include a fixed fluid flow outlet or an adjustable fluid flow outlet. The fixed fluid outlet may be defined by one or more openings. The one or more openings may be formed or defined in the housing. The adjustable fluid flow outlet may be adjusted to vary the direction of fluid flow from the lighting device. The adjustable fluid flow outlet may comprise an eyeball. The lighting device may include a mounting adapted for connecting the housing to a fluid flow pipe. The engagement portion may include an integral spigot for releasable engagement with the fluid flow pipe. The spigot may be hollow to define a fluid flow passage for communicating the fluid flow pipe with the fluid outlet in the housing.

Alternatively the lighting device may include mounting means for mounting the housing to a wall such as a wall of a liquid container. The mounting means may comprise a threaded spigot which may be passed through an opening in the wall secured thereto by a nut. Alternatively, other mounting means may be provided for mounting the housing on a wall.

The light source or sources most preferably comprise a solid state light emitting device such as a light emitting diode (LED) or diodes. Preferably where more than one light emitting device is provided, they are arranged around the fluid flow outlet or outlets. Preferably the light emitting devices are provides at a circumferential spacing around the fluid flow outlets. The housing may include a front wall having a plurality of openings therein through which respective light emitting diodes project. The front wall of the housing may comprise a wall of a radially extending flange or channel to which the light emitting devices are mounted. The channel may include therein a suitable waterproof sealing material to seal the electrical connections to the light emitting diodes.

### BRIEF DESCRIPTION OF THE DRAWINGS

Reference will now be made to the accompanying drawings which illustrate preferred embodiments of the invention and wherein:

FIG. 1 is a front elevation of one embodiment of lighting device of the present invention;

FIG. 2 is a cross section of the lighting device of FIG. 1 taken along the line A-A and located in a pool wall;

FIG. 3 is a front elevation of another embodiment of lighting device of the present invention;

FIG. 4 is a cross section of the lighting device of FIG. 3 taken along line B-B and located in a pool wall;

FIG. 5 is a front elevation of another embodiment of lighting device of the present invention;

FIG. 6 is a cross section of the lighting device of FIG. 5 taken along the line C-C and located in a pool wall;

FIG. 7 illustrates in front elevation a further embodiment of lighting device of the invention;

FIG. 8 is a sectional view of the lighting device of FIG. 7 along lines D-D;

FIG. 9 is a rear elevation of the lighting device of FIGS. 7 and 8;

FIG. 10 is a schematic plan view illustrating the general manner in which the light assemblies are installed in a pool;

FIG. 11 illustrates schematically the manner in which a single lighting device may be installed in a pool water return line;

FIG. 12 illustrates an alternative installation method for the lighting device in a pool;

FIG. 13 is a schematic view of an alternative lighting device according to the invention;

FIG. 14 is a schematic cross sectional view illustrating the manner in which the lighting device of FIG. 13 is installed;

FIG. 15 illustrates a lighting device for use in above ground pools or similar applications;

FIG. 16 illustrates the manner in which the lighting device of FIG. 15 is supported to a pool wall or the like; and

FIG. 17 is a sectional view of a lighting device designed for use in water features such as fountains, sprayers or the like.

### DETAILED DESCRIPTION OF THE PREFERRED EMBODIMENT

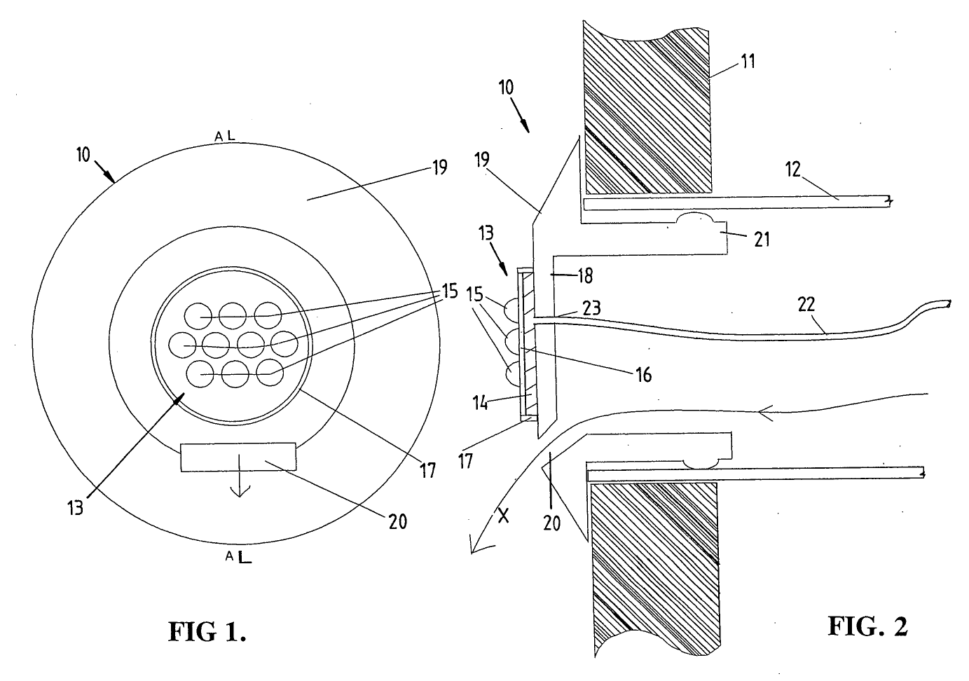

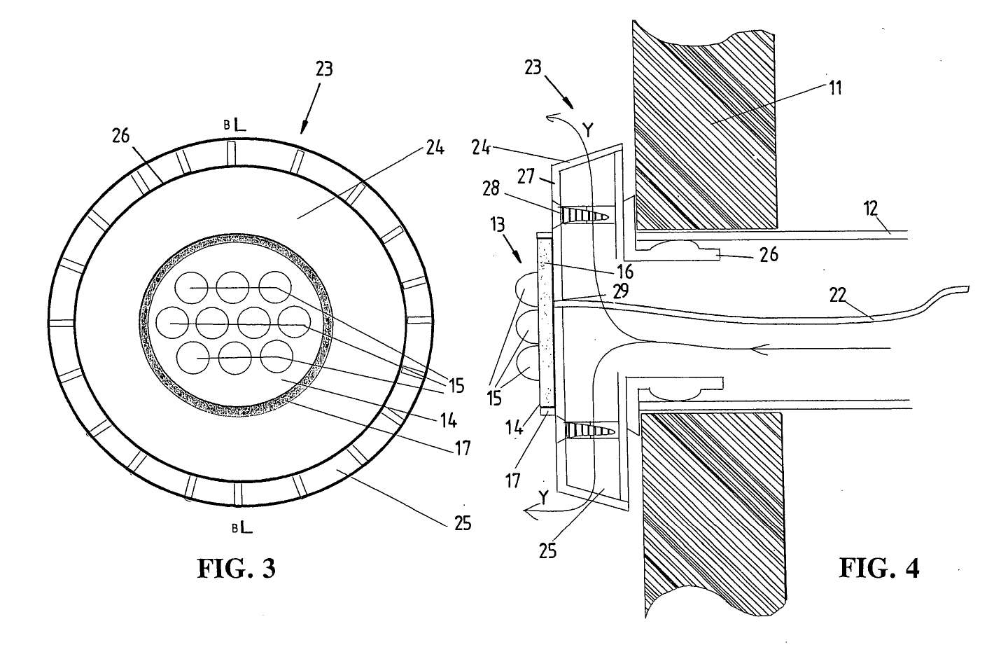

Referring firstly to FIGS. 1 and 2, there is shown one embodiment of underwater light/water return device 10 according to the present invention which is designed for submerged placement in a body of water such as a swimming pool having a side wall 11 typically formed of concrete and having a pool return line 12 for returning water from a filter to the pool, the return line 12 normally comprising a PVC plastics pipe and being embedded within the pool wall 11 during construction of the pool.

The underwater light/water return device 10 includes a light assembly 13 comprising a printed circuit board 14 on which are mounted a plurality of light emitting diodes (LEDs) 15 arranged in an array in this case of three rows. A waterproof compound 16 such as rubber, epoxy resin or other material encapsulates the bases of the light emitting diodes 15 and is encircled by a retaining ring 17 formed of PVC or a similar material.

The light assembly 13 is mounted on to the front wall or flange 18 of a ‘letterbox’ pool return fitting 19 having a pool water return outlet 20 therethrough. The light assembly may be mounted to the wall 18 by means of solvent welding, by adhesives or other connection method or alternatively, a housing for the light assembly 13 may be injection moulded with the return fitting 19. Alternatively a separate housing for the light assembly 13 may be injection moulded and mounted in any suitable manner to the front wall or flange 18. The pool return fitting 12 includes as is conventional, a spigot 21 adapted for a push fit into, for frictional engagement, with the pool return line 12.

A power supply cord 22 for supply of current to the light assembly 13 is passed through a hole 23 drilled or formed the front wall 18 of the pool return fitting 12 prior to the affixing of the light assembly 13 to the wall 18 and is connected to the light emitting diodes 15 which are arranged in parallel with each other. The power cord 22 passes along the pool return line 11 for connection to a power supply usually an above ground power supply. The power cord 21 may pass out of the return line 12 through a suitable gland or other means which seal the cord to the return line 12 to prevent escape of water from the return line 12.

It will be apparent that the attachment of the light assembly 13 to the pool return fitting 19 does not interfere with the operation of the fitting 19 as it still allows water to flow out of the fitting 19 through the outlet 20 as indicated by the arrow X whilst at the same time, the fitting 19 provides a convenient means for mounting of the light assembly 13 to the return line 12. A convenient means is also provided for supplying current to the light assembly 13 via the power cord 22 located within and passing along the return line 12 without the necessity of using separate conduits or other wiring externally or internally of the pool.

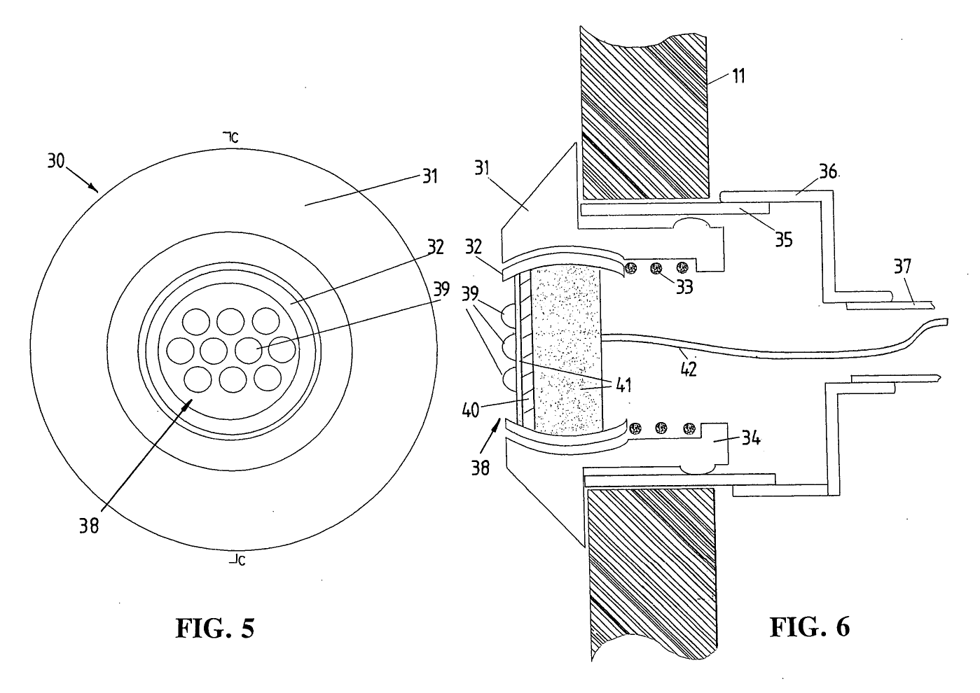

Referring to FIGS. 3 and 4, there is shown another embodiment of the underwater light/pool return device 23 of the present invention in which similar components to the components of the embodiment of FIGS. 1 and 2 have been given like numerals. As shown in FIG. 3, the underwater light/water return device 23 comprises in this case, an outlet fitting 24 comprising a “safety suction” fitting provided with water inlet/outlets 25 around its periphery which comprise a series of open vents moulded around the entire, or partial, edge of the fitting 24 and which is used in this case as a pool water return fitting. The fitting 24 additionally includes a spigot 26 adapted for a push fit into and frictional engagement with a pool return line 12 embedded in the pool wall 11. The fitting 24 additionally includes a detachable front wall or face plate 27 secured to the main body of the fitting 24 by screws 28.

As before, an underwater light assembly 13 on the device 23 includes a printed circuit board 14 on which are mounted an array of light emitting diodes (LEDs) 15, encircled by a PVC or similar retaining ring 17, and encapsulated in a waterproof compound 16 of rubber, epoxy resin or other material.

The light assembly 13 is mounted on to the front wall or face plate 27 of the pool fitting 12 by means of solvent welding, injection moulding or adhesives. A power supply cord 22 is threaded through a hole 29 drilled or formed in the front wall 27 of the return fitting 23 prior to the affixing of the light assembly 13 to the wall 27. The power cord 22 is connected to the light emitting diodes 15 which are arranged in parallel with each other.

As in the embodiment of FIGS. 1 and 2, when the fitting 23 is frictionally engaged with the pool return line 12, the attachment of the light assembly 13 to the fitting 24 does not interfere with the operation of the fitting 24 as it still allows water to flow in any direction out of the fitting 24 through the outlets 25 as indicated by the arrow Y in FIG. 4.

The power supply for the light assemblies 13 in the above embodiments to which the power cord 22 is connected is preferably mains power via a transformer or transformers. The light assemblies 13 however may be battery powered. In the illustrated embodiments, the light assemblies 13 have a power consumption of approximately 200 milliwatts whilst the light emitting diodes 15 have a life expectancy in excess of 50000 hours. Thus changes of light emitting diodes 15 are not required for many years. Further the light assemblies are capable of operating on standard lead acid or any other rechargeable battery for hundreds of hours before recharging is necessary.

FIGS. 5 and 6 illustrate yet an alternative embodiment of under water light/water return device 30 according to the present invention. In this case, the device 30 includes an conventional swimming pool eyeball wall fitting 31 having a movable eyeball 32 which is retained in position by a retaining spring 33 and which includes a spigot 34 for frictional engagement with an enlarged pipe section 35 embedded in the wall 11 of the pool, the pipe section 35 being connected through a reducer 36 to a conduit 37.

A light assembly 38 comprising an array of light emitting diodes (LEDs) 39 are mounted on a printed circuit board (PCB) 40 arranged within the eyeball 32 and embedded with a waterproofing compound 41 substantially filling the eyeball 32. A power cord 42 for supplying power to the light assembly 38 is connected to the light emitting diodes 39 (which are arranged in parallel) and extends along the conduit 37 for connection to a power supply either mains power via a transformer or battery supply usually above ground.

In this case, water is not supplied along the conduit 37 however the eyeball 32 is rotatable in multiple directions as in a conventional eyeball fitting to adjust the direction in which light is emitted from the light assembly 38. The eyeball fitting 32 may comprise any form of eyeball fitting.

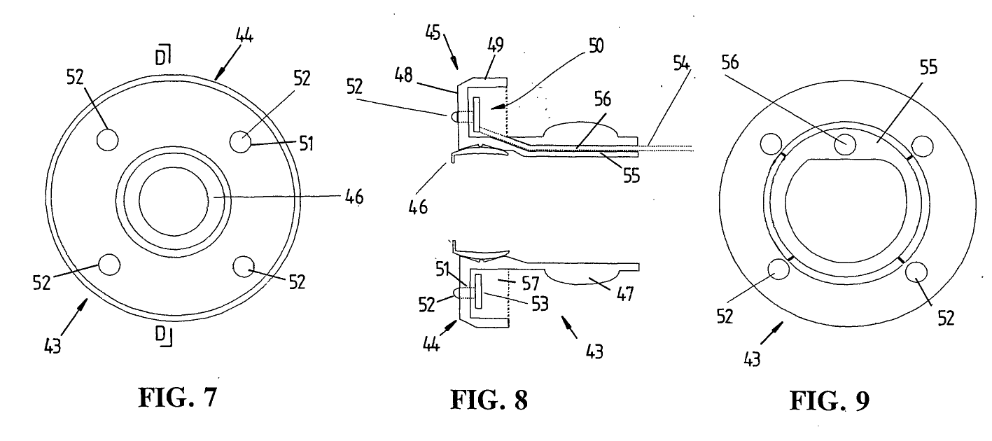

Referring now to FIGS. 7 to 9, there is illustrated a further embodiment of underwater light/water return device 43 according to the invention comprising an eyeball type water return fitting 44 having an outer housing 45 in which an eyeball 46 is mounted for rotation in a range of directions and which includes a spigot 47 for push fit mounting of the fitting 44 in a pool return line. The housing 45 includes an outer front flange 48 which terminates at its outer edge in a return flange or skirt 49 such as to define a channel 50 on the rear side of the flange 48.

The front flange 48 is provided with a plurality of apertures 51 in this case four apertures circumferentially spaced around the flange 48 through which respective light emitting diodes 51 project, the light emitting diodes 51 being mounted on an annular printed circuit board 53. A power supply cord or cable 54 is connected to the light emitting diodes 52 which are arranged in parallel. The spigot 47 of the return fitting 44 includes a thickened wall portion 55 having a bore 56 extending in an axial direction therealong through which the cable 54 may pass for connection to the light emitting diodes 52. The channel 50 is filled with a waterproofing compound 57 such as an epoxy resin or rubber which encapsulates the printed circuit board 53 to seal the circuit board and electrical connections from entry of water.

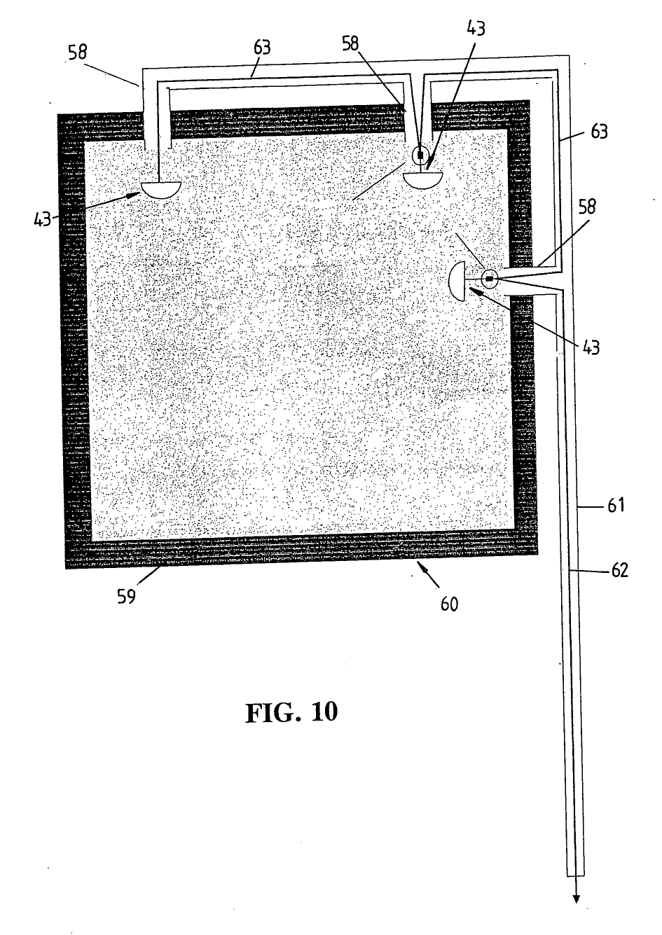

As shown in FIG. 10, the devices 43 are typically installed in the pool return outlets 58 which penetrate the wall 59 of a pool 60, the return outlets 58 typically being PVC pipes and being connected to a common pool return line 61 which is connected to the pool filtering apparatus (not shown). A single power supply cable 62 passes along the pool return line 58 and is connected to one of the devices 43 with connecting cables 63 connected between adjacent devices 43.

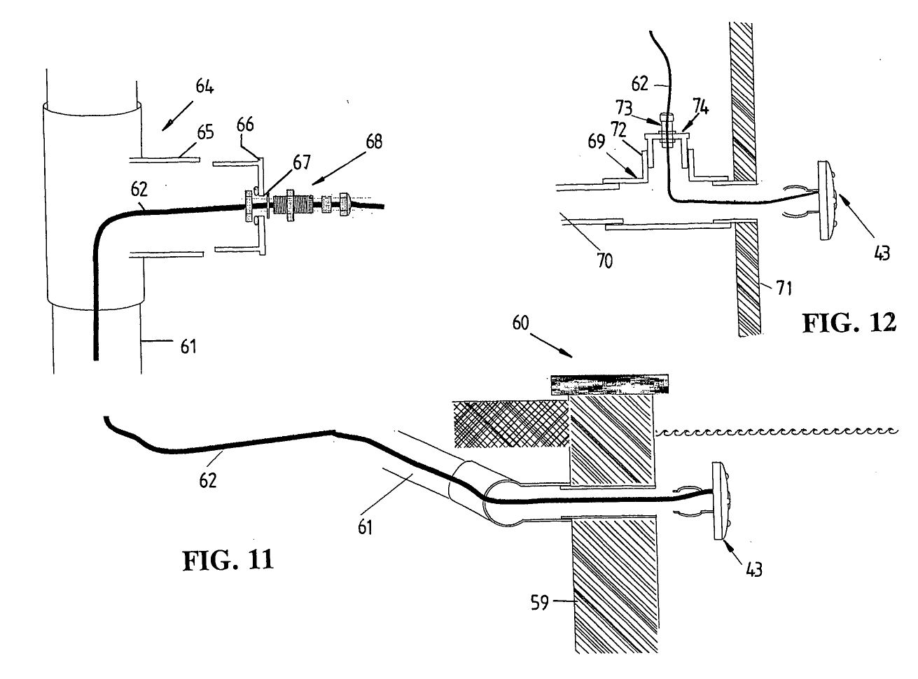

For installation purposes and as shown in FIG. 11, the return line 61 is severed adjacent the pool pump and a T-section fitting 64 fitted to the line 61. The cable 62 connected to a lighting device 43 is passed along the line 61 and out through the leg 65 of the T-fitting 64. An end cap or plug 66 is engageable with the T-section leg 65 and has an opening 67 for receipt of a gland assembly 68 through which the cable 62 is passed. Thus when the cap or plug 66 is sealed to the leg 65 of the T-section 64, water is prevented from escaping through the T-section leg 65. Although only one gland assembly 68 is shown in FIG. 11, a number of gland assemblies 68 may be provided in the end cap 66 for respective cables 61 connected to different lighting devices 43. The cable or cables 59 are then connected to a suitable power supply such as mains power through a transformer or a battery supply. The above method of installation is particularly suited for installation of the lighting devices 43 where the pool 60 is an existing in-ground pool.

In an alternative method of installation as illustrated in FIG. 12 which is particularly suited to installation of lighting devices 43 in a pool during the construction thereof or where access to the return line adjacent the pool wall is available, a T-section fitting 69 is installed in the pool return line 70 adjacent to the pool wall 71. In this case, the cable 62 passes out of the leg 72 of the T-section 69 and through a gland assembly 73 mounted on an end cap 74 sealed to the leg 72 in a similar manner to that described with reference to FIG. 11. The cable 62 may then be fed to the surface in the earth for connection to the power supply. Alternatively, the cable 62 may be located within a conduit for passage to the surface.

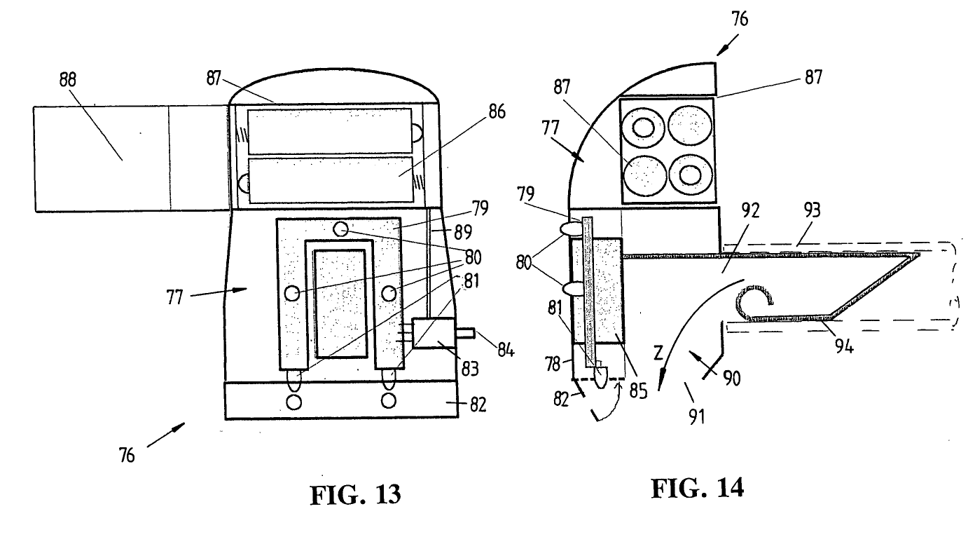

Referring now to FIGS. 13 and 14, there is illustrated a further form of underwater lighting device 76 according to the present invention. The lighting devices 76 includes a hollow housing 77 having a front wall 78 behind which a printed circuit board 79 is mounted. A plurality of light emitting diodes 80 are mounted on the board 79 and project through the front wall 78. Further light emitting diodes 81 are also mounted to the board 79 and extend through a lower wall 82 of the housing 77 which is hinged to the wall 78 through an integral hinge. A switch 83 is also mounted on the printed circuit board 79 for controlling supply of current to the light emitting diodes 80 and 81, the switch 83 having an operating button or lever 82 extending through the side of the housing 77.

The printed circuit board 79 and the rear of the light emitting diodes including the electrical terminals thereof and the switch body and its terminals are encapsulated in a waterproofing or sealing material 85 such as an epoxy resin. Power for supply of current to the light emitting diodes 80 and 81 is provide by a series of batteries such as rechargeable batteries 86 mounted within a removable battery box 87. The battery box 87 has a flip lid 88 providing access to the box 87. Electrical wires 89 connect the batteries 86 or terminals on the battery box 87 via the switch 83 to the light emitting diodes 60 and 81.

The housing 77 has a chamber 90 on its rear side which has a downwardly directed outlet 91 and inlet opening 92 for alignment with a pool return line 93. In addition, a resilient spigot 94 in the form of a spring clip extends rearwardly of the housing 77 for insertion in use into the pool return line 93 to be a push fit within the return line 93 to secure the lighting device 76 in position.

In the installed position, and where water is returned to the pool via the pool return line 93, water will flow into the inlet opening 92 and out of the outlet 91 as indicated by the arrow Z in FIG. 14 to flow into the pool. The lighting device 76 may be turned on simply by operating the switch lever or button 84 to supply current to the light emitting diodes 80 and 81.

For replacement of batteries 86, the lighting device 76 may be simply detached from the pool return line 93 by withdrawing the spigot 94 from the line 93 to provide access to the battery box 87 and the batteries 86 therein.

It will be appreciated that the lighting devices described in the above embodiments may be of many different designs and either powered remotely from a battery or mains power supply by a supply line or cable or by on-board batteries.

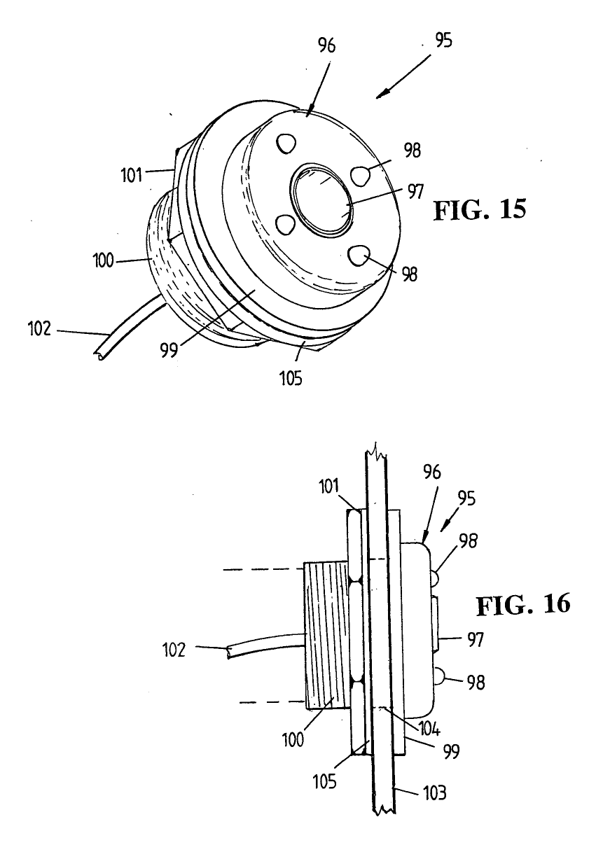

The above lighting devices are described in association with in-ground swimming or spa pools. The lighting devices may also be adapted for use with above-ground pools as shown in the embodiment of FIGS. 15 and 16. The lighting device 95 in this case is similar to the embodiment of FIGS. 7 to 9 having a housing 96 supporting an eyeball 97 defining a fluid outlet and which carries light emitting diodes 98 spaced circumferentially around the eyeball 97. The housing 96 also includes a front flange 99 and a hollow externally threaded spigot 100 for threaded engagement by a flanged nut 101. A cable 102 is provided to supply power to the light emitting diodes 98.

For installation in an above ground pool (or for mounting on any other wall) and as shown in FIG. 16, the wall 103 is provided with an opening 104 through which the spigot 100 can project for threaded engagement by the nut 101 to clamp the lighting device 95 to the wall 103. An annular seal 105 may be provided between the nut 101 and wall 103.

The spigot 100 is then connected to a return line (shown in dotted outline) to the pool and the supply cable 102 may be passed along the return line in the manner described above in relation to in-ground pools for connection to a power supply.

Of course the lighting device 95 may be simply mounted to any wall and not connected in a water return line but connected alternatively to any fluid supply line.

Whilst the lighting devices have been described above in relation primarily to swimming and spa pools, they may be used in water features in which water is pumped through the lighting device. Thus the lighting device of the embodiment of FIGS. 7 to 8 may be used in for example a waterfall with water pumped through the flow passage through the hollow spigot 47 out of the eyeball 63 with the water flow being illuminated by the light emitting diodes 52. Such an arrangement does not require a separate light source for illumination of the water flow as the light sources are incorporated within the lighting device.

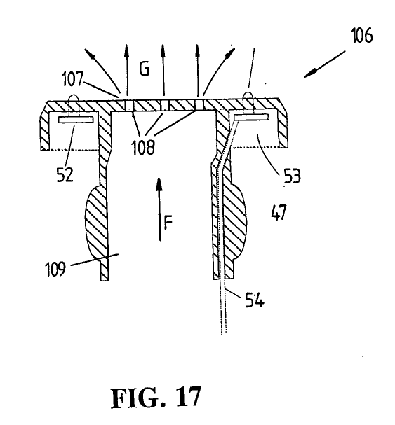

A further lighting device 106 for use in fountains, water features, sprays or the like is illustrated in FIG. 17. The lighting device 106 is similar to the embodiment of FIGS. 7 to 9 and like components thereto have been given like numerals. In this case however the eyeball 46 is replaced by a transversely extending fixed wall 107 having a series of outlet openings 108 therein. The spigot 47 as before defines a flow passage 109 through which water can flow in the direction indicated by the arrow F to exit through the openings 108 as indicated by the arrow G. The latter flow may be in the form of a spray. The flow G can be illuminated by the light emitting diodes 52 which may be supplied with current from supply cable 54. The outlet openings 108 can be in many different configurations depending upon the nature of the flow required therefrom for producing for example a spray or flow of a desired form.

The present invention thus provides in one aspect an underwater light and pool water return device for internal illumination, and water return function, of swimming pools, spas, ponds and the like, which operates with externally sourced power from either a low voltage ‘plug pack’ or battery. In other aspects the lighting devices may be used in water features such as waterfalls or fountains with the flow of water through the assemblies being illuminated by the light emitting diodes contained within a common housing.

Power is supplies to the light assemblies either form a mains supply or in an alternative embodiment, power may be supplied to the LED assemblies by batteries incorporated in housings within the devices for example on the rear side of the front flanges/faces of the return fittings 10 and 23 of the embodiments of FIGS. 1 to 4. Similarly batteries may be incorporated within the spigot 34 of the embodiment of FIGS. 5 and 6.

The light sources are suitably high intensity LED's but may be other solid state light emitting devices. The LED's where used may also be multi-coloured LEDs.

The terms “comprising” or “comprises” or derivatives thereof as used throughout the specification and claims are taken to specify the presence of the stated features, integers and components referred to but not preclude the presence or addition of one or more other feature/s, integer/s, component/s or group thereof.

Whilst the above has been given by way of illustrative embodiment of the invention, all such variations and modifications thereto as would be apparent to persons skilled in the art are deemed to fall within the broad scope and ambit of the invention as defined in the appended claims.

1. An underwater lighting device for use with a liquid container of the type having at least one return line for returning water to said liquid container, said lighting device including a main support body for supporting one or more light sources, and locating means for cooperation with said return line to locate said lighting device in said liquid container.

2. A lighting device as claimed in claim 1 wherein said support body has one or more water outlets through which water flowing through the return line can return to the liquid container.

3. A lighting device as claimed in claim 1 and including a wire or cable for supplying current to said light source, said wire or cable extending in use along said return line for connection to a power supply.

4. A lighting device as claimed in claim 1 wherein said support body supports a power supply whereby said lighting device is self contained.

5. A lighting device as claimed in claim 1 wherein said locating means comprise engagement means which are frictionally engageable with said return line.

6. A lighting device as claimed in claim 1 wherein said main support body has a liquid outlet for flow of water from the return line to the liquid container.

7. A lighting device as claimed in claim 6 wherein said main support body comprise a pool return fitting and said locating means comprises a spigot formed integrally with or fixed to the main body.

8. A lighting device as claimed in claim 7 wherein said spigot is of hollow tubular form and defines a flow passage for communicating the return line with the liquid outlet or outlets.

9. A lighting device as claimed in claim 1 wherein said main support body has a front face and wherein said light source is mounted on said front face.

10. A lighting device as claimed in claim 1 wherein said light source comprise at least one solid state light emitting device.

11. A lighting device as claimed in claim 10 wherein said light source comprises a plurality of light emitting diodes.

12. A multidirectional underwater lighting device for use in a liquid container, said lighting device comprising a light source support body for supporting a light source and a mounting portion for mounting said support body to said liquid container, said support body being movable relative to said mounting portion in a plurality of directions relative to said mounting portion.

13. A lighting device as claimed in claim 12 wherein said mounting portion is releasably engageable with a pipe or housing in a wall of the water container.

14. A lighting device as claimed in claim 13 wherein said support body and mounting portion comprise an eyeball pool return fitting, said support body comprising an eyeball of said fitting and said mounting portion comprising a spigot of said fitting.

15. A lighting device as claimed in claim 13 wherein said light source comprise a plurality of light emitting diodes mounted to said eyeball.

16. A lighting device including a housing adapted to be connected to a source of fluid, said housing having a fluid flow outlet for said fluid, and said housing supporting one or more light sources for illuminating fluid flow through said outlet.

17. A lighting device as claimed in claim 16 wherein said fluid outlet comprises one or more openings formed or defined in the housing.

18. A lighting device as claimed in claim 17 and including an engagement portion for mounting said housing to a fluid flow pipe.

19. A lighting device as claimed in claim 18 wherein said engagement portion comprises a spigot for releasable engagement with the fluid flow pipe.

20. A lighting device as claimed in claim 19 wherein said spigot is hollow and defines a fluid flow passage for communicating said fluid flow pipe with said outlet.

21. A lighting device as claimed in claim 16 and including means for mounting said housing to a wall.

22. A lighting device as claimed in claim 21 wherein said mounting means includes a threaded spigot for passage through an opening in said wall for engagement with a nut.

23. A lighting device as claimed in claim 16 wherein said light source comprise a solid state light emitting device.

24. A lighting device as claimed in claim 23 wherein said light source comprise a plurality of light emitting diodes arranged at a circumferential spacing around said fluid flow outlet.

25. A lighting device as claimed in claim 24 wherein said housing includes a front wall having a plurality of openings therein through which respective light emitting diodes project.
